(19) United States
(12) Patent Application Publication
(10) Pub. No.: US 2002/0124026 A1
(43) Pub. Date: Sep. 5, 2002

(54) Methods and apparata for enhancing text to increase reading speed and comprehension

(76) Inventor: David J. Weber, Cottage Grove, WI (US)

Correspondence Address: Intellectual Property Department, DEWITT ROSS & STEVENS S.C., Firstar Financial Centre, 8000 Excelsior Drive Suite 401, Madison, WI, 53717-1914, US

(21) Appl. No.: 09/799,145

(22) Filed: Mar. 5, 2001

(51) Int. Cl. G06F 17/21; G06F 17/24

(52) U.S. Cl. 707/526; 707/513

(57) ABSTRACT

Input texts, e.g., electronic text files containing a written work, are received by the invention. Selected visual characteristics of text, such as such as font case, font type, font size, font color, word spacing, and line spacing, are automatically applied to the text and are varied within the text to produce enhanced text. The variation may occur as frequently as character to character, or word to word, sentence to sentence, line to line, paragraph to paragraph, or some other frequency. The resulting enhanced text is visually different from the received text (provided the applied variations are not already present in the received text). The enhanced text is then visually displayed to a reader, as by providing it on a computer monitor or in printed form. The enhanced text, having more visible variety than the received text, is believed to result in greater reading speed, comprehension, and/or interest in people having certain types of reading deficiencies.

### FIELD OF THE INVENTION

This disclosure concerns an invention relating generally to methods and apparata for treating reading disorders and enhancing reading speed and comprehension, and more specifically to methods and apparata for modifying text to achieve these objectives.

### BACKGROUND OF THE INVENTION

For many people, particularly those with cognitive disorders such as dyslexia or attention deficit disorder (ADD), reading is a difficult task. Reading is known to utilize language processing centers in the left or “logical” side of the brain, which controls analytical and logical cognitive processing. The right or “artistic” side of the brain is primarily responsible for processing visual and spatial input. It is accepted that most people have a “dominant” half of the brain, and in nearly all right-handed and many left-handed people, the left hemisphere is dominant.

For those people who have a dominant right hemisphere, or who suffer from cognitive disorders, reading can be far more difficult. The inventor of the methods and apparata described in this document theorizes that many reading disorders stem from right brain/left brain “dissonance”, wherein the written language processing centers of the left hemisphere of the brain are less developed than parallel visual processing areas of the right hemisphere. As a result, a printed page is difficult to process because of the underdeveloped language centers, and the problem is compounded because the “static” image (such as the printed page) provides little stimulation for the visual processing centers. In contrast, colorful, and rapidly changing “dynamic” visual inputs may be very attractive to one who has this condition. This may account for the high incidence of underdeveloped reading skills in those who suffer from ADD: the regularity of appearance of the written word simply does not provide sufficient mental stimulation to hold one's interest. This problem can have significant ramifications; it is recognized that reading disorders can lead to illiteracy because of the discouragement and difficulty that one suffers when attempting to read, and that illiteracy is a serious social problem because reading is the gateway to many other aspects of learning.

Studies have been done on the “readability” of text, i.e., on ways of presenting text so that it may be more easily processed by the human brain for enhanced reading speed and comprehension. However, most of the studies known to the inventor focus on issues of which font sizes, font types, number of words per line, etc. work best to enhance reading speed and comprehension for the general public. The results of these studies are generally of marginal use to persons with reading disorders because the allegedly “optimized” text is no more easy to mentally process, and in fact such “optimization” may give text an even more regular appearance, making it yet more difficult to read. There is a significant need for further studies devoted to alleviating the difficulties encountered by those who suffer from reading disorders, and for devices and methods which help alleviate these difficulties.

SUMMARY OF THE INVENTION

The invention involves methods and apparata for enhancing text for increased reading speed, comprehension, attention span, and/or enjoyability, the invention being intended to at least partially solve the aforementioned problems. To give the reader a basic understanding of some of the advantageous features of the invention, following is a brief summary of preferred versions of the invention. As this is merely a summary, it should be understood that more details regarding the preferred versions may be found in the Detailed Description set forth elsewhere in this document. The claims set forth at the end of this document then define the various versions of the invention in which exclusive rights are secured.

The method of the invention is preferably implemented on software, firmware, or another form which allows rapid preparation of enhanced texts from supplied input text files. Certain characteristics of text, such as font case, font type, font size, font color, word spacing, and line spacing, all have visually perceivable features; upper case text is visually distinguishable from lower case text, each font type is visually distinguishable from others, each font size is distinguishable from others, and so on. When the invention receives an input text to be enhanced—e.g., an electronic text file containing a written work—selected visual characteristics are varied within the text to produce enhanced text. For example, an input text might consist of the following:

This is a sample input text to be visually enhanced by the invention.

If the selected visual characteristic is the characteristic of font case, the enhanced text output by the invention might then consist of:

tHiS iS a SaMpLe InPuT tExT tO be vIsUaLlY eNhAnCeD bY tHe InVeNtIoN.

The variation may occur as frequently as character to character, or word to word, sentence to sentence, line to line, paragraph to paragraph, or some other frequency. Such variation preferably occurs among user-specified preferences for each visual characteristic; for example, where the user selects 12, 14, and 16 point font sizes as being preferences for the visual characteristic of font size, the font sizes in the enhanced text will vary among these preferences. The resulting enhanced text is visually different from the received input text provided the applied variations are not already present in the received text. The enhanced text is then visually displayed to a reader, as by providing it on a computer monitor or other electronic display, or in printed form. The enhanced text, having more visible variety than the received text and containing the user's preferences for the visual characteristics in issue, is believed to result in greater reading speed, comprehension, and/or interest in people having certain types of reading deficiencies. While the exact reasons for this benefit are unknown, it is hypothesized that during reading, the variety of the enhanced text provides more stimulation to the right brain, i.e., those portions of the brain which deal with visual processing. In contrast, reading standard text is primarily a left brain activity (the left hemisphere containing those portions of the brain which deal with language processing). Additionally, since the enhanced text contains the user's most preferred alternatives for each of the visual characteristics, and these preferences are presumably more visually appealing to the reader, the enhanced text is presumably “optimized” (or at least more optimal) for right brain processing by the reader who chose the preferences. Thus, reading the enhanced text becomes more of a “whole brain” activity, increasing the reader's ability to process the enhanced text as compared to the received text.

The visual characteristics may be varied within the input text in a number of different ways. Most preferably, the user is allowed to select some number Q of visual characteristics to be varied, and also selects the various preferred alternatives for that visual characteristic (e.g., where the visual characteristic of font size is selected, the user may also select his most preferred font sizes). The user may then select a number of change frequencies X₁, X₂, . . . X_{Q}, with each change frequency corresponding to one of the selected visual characteristics and specifying how often that visual characteristic is to vary among its chosen preferences. Such variation may occur either randomly or sequentially among the chosen preferences.

Preferably, the user is then provided with an option to store the selected visual characteristics, the preferred alternatives selected for each visual characteristic, and/or the change frequencies so that the user may later apply them to other input texts. This allows the user to create enhanced texts having the preferred visual characteristics and change frequencies that the user feels most comfortable with, and/or that produce the greatest reading speed and/or comprehension.

Further advantages, features, and objects of the invention will be apparent from the following detailed description of the invention in conjunction with the associated drawings.

### BRIEF DESCRIPTION OF THE DRAWINGS

FIG. 1 illustrates an exemplary input text which may be received by the invention.

FIG. 2 illustrates an exemplary enhanced text generated from the received text of FIG. 1 after the visual characteristic of font case is regularly varied between upper and lower case with a change frequency of every three alphanumeric characters.

FIG. 3 illustrates an exemplary enhanced text generated from the received text of FIG. 1 after the visual characteristic of font size is regularly varied between 12-point, 14-point, and 10-point type with a change frequency of every two words (every two alphanumeric groups), and the visual characteristic of font type is randomly varied between the Arial, Times, and Courier fonts with every four alphanumeric characters.

FIG. 4 illustrates an exemplary enhanced text generated from the received text of FIG. 1 after the visual characteristic of font size is randomly varied between 10-point, 12-point, and 14-point type with a change frequency of every four words (every four alphanumeric groups), the visual characteristic of word spacing is regularly varied between one, two, and three spaces with a change frequency of every three words (every three alphanumeric groups), and the visual characteristic of line spacing is randomly varied between 1, 1.25, 1.5, and 2 spaces with a change frequency of every two lines.

FIG. 5 illustrates an exemplary visual characteristics survey screen for the visual characteristic of font size, wherein the user may select his preferred font sizes and the type and degree of variation between the selected font sizes to be applied to the input text (and displayed in the resulting enhanced text).

FIG. 6 illustrates the visual characteristics survey screen of FIG. 5 wherein the user chooses small, medium, and large font sizes; a change frequency of every five change units, with the change units being (alphanumeric) characters; and the change being applied on a regular (sequential) basis, with exemplary text then illustrating a sequential change between small, medium, and large font sizes every five alphanumeric characters.

FIG. 7 illustrates the visual characteristics survey screen of FIG. 5 wherein the user chooses X-small, medium, and X-large type; a change frequency of every six change units, with the change units being words; and the change being applied randomly, with exemplary text then illustrating a random change between X-small, medium, and X-large type every six words.

FIG. 8 illustrates an exemplary visual characteristics survey screen for the visual characteristic of font type, wherein the user may select his preferred font types and the type and degree of variation between the selected font types to be applied to the input text (and displayed in the resulting enhanced text).

FIG. 9 illustrates the visual characteristics survey screen of FIG. 8 wherein the user chooses Times, Courier, Lucida, and Script type; a change frequency of every six change units, with the change units being words; and the change being applied randomly, with exemplary text then illustrating a random change between Times, Courier, Lucida, and Script type every six words.

### DETAILED DESCRIPTION OF PREFERRED EMBODIMENTS OF THE INVENTION

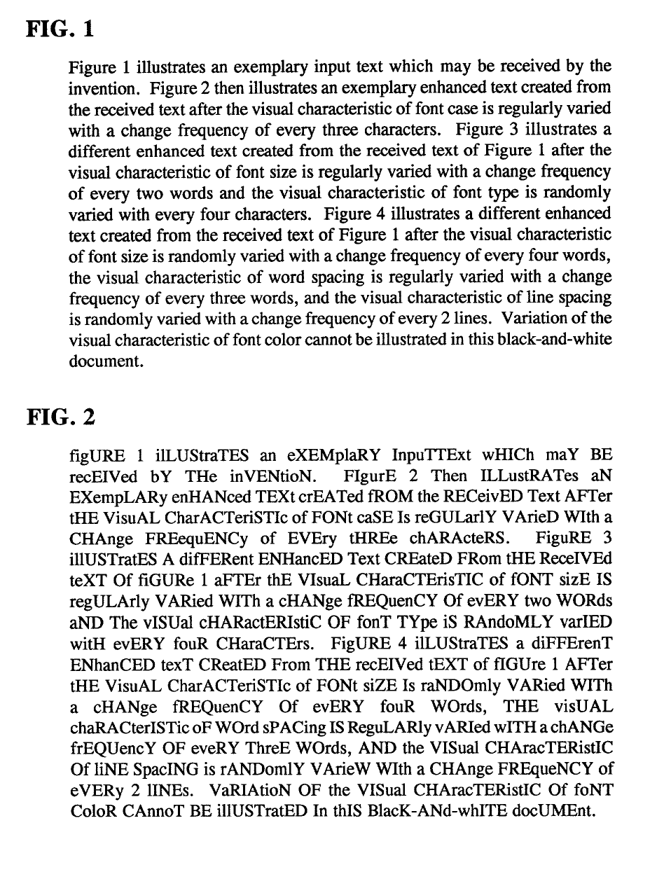

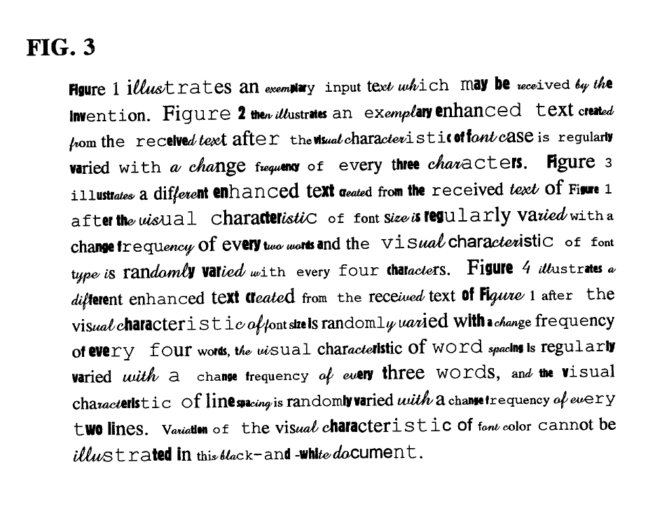

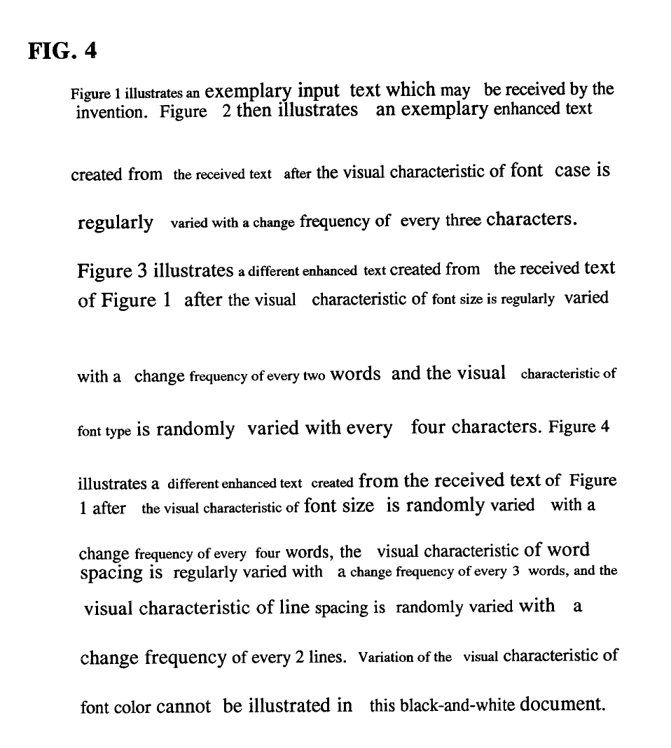

Particularly preferred embodiments of the invention will now be described to assist the reader's understanding. By way of introduction to the invention, it is initially helpful to look at an exemplary input text received by the invention (FIG. 1), and then compare it to exemplary enhanced text produced by the invention from the received text (FIGS. 2-4). Looking initially to FIG. 1, the exemplary input text appears much the same as any common text encountered in print media: the text consists of alphanumeric and punctuation characters presented in a single font and single font size, presented in a single color on a uniformly-colored background (here black print on a white background). The spacing between the characters, words, and lines is also uniform, at least as perceived by the eye. Most words are presented in lower case, except that characters at the beginning of sentences, names, and the like are presented in upper-case letters. While the words differ in appearance insofar as they display variation in their characters and character order, and differences in word and sentence length are also present, the text nonetheless has a relatively uniform appearance. To those with normally-functioning written language processing centers, such uniformity may even enhance reading because the uniform appearance of the text may speed character recognition, and thus the processing of the various letters and words. To those who suffer from reading disorders, the uniformity will not offer significant assistance.

When analyzing the exemplary text (or any other text) for its visually-perceptible features, the following visual characteristics can be identified (among others):

Font Type: A written work's alphanumeric and other characters are generally presented in a uniform font type wherein all characters have a uniform stylistic format. Numerous fonts are available, and common fonts used to display text for reading are Times, Helvetica, Arial, Chicago, and Geneva.

Font Case: Font case has a binary value, with each alphanumeric character assuming a value of lower case (example: lower case) or upper case (example: UPPER CASE). Most written works are presented in predominantly lower case characters (though names, titles, and the like may begin with upper case characters), or are otherwise provided in solely upper case characters.

Font Size: Most common written works are presented with a uniform font size (i.e., text size) throughout their text. The font size is generally represented by “points,” but in other cases, fonts may be represented by a “base” font size which is absolute, and which may then be scaled by a factor to different sizes (often represented as XX-small, X-small, small, medium, large, X-large and XX-large).

Font Style: Font style relates to modifications that can be done to font types, such as italic style (slightly slanted text), oblique style (highly slanted text), bold style (where the text characters are given greater thickness), outline style (wherein the text characters are defined by lines bounding the area wherein the text character rests), underline style (wherein the text characters are underlined, and so on. Since these properties are often represented by independent font types—for example, italicized Times text may be represented by a separate Times italics font—the feature of font style may be regarded as being encompassed within font type (an assumption which is utilized throughout this document). Font styles are generally maintained constant throughout most written works, though titles, headings, and other matter of this nature may be provided in a different text style.

Font Color: On computer systems and similar media which have the capability of displaying different colors, users often have the option of selecting a color in which to display text (generally selected as uniformly black, though other colors, generally the primary colors, are commonly available). Printed text may be presented in different colors as well.

Character Spacing: Character spacing (often referred to as kerning) refers to the spacing provided between adjacent text characters. Character spacing is generally constant throughout most written works.

Word Spacing: Word spacing refers to the space between adjacent words of the text; viewed differently, it may be regarded as the width of the “null” character (space character) between words of the text. By varying word spacing, words may be displayed closer together or farther apart. Word spacing is generally constant throughout most written materials (at least as seen to the human eye).

Line Spacing: Line spacing refers to the vertical distance between adjacent horizontal lines of text, and is generally set to a constant value in most printed text.

Margin Alignment: Margin alignment refers to the alignment of the left and/or right sides of each line of text to the assigned margins of the text. Most text is presented in “full justification”, i.e., the leftmost character in each (or most) lines is aligned flush with the assigned left margin, and the rightmost character in each (or most) lines of text is aligned flush with the assigned right margin for the text. The text may also be presented with “ragged right” margin alignment, wherein only the leftmost character in each or most lines is aligned with the assigned left margin, and the rightmost characters in each or most lines have variable distance from the assigned right margin. Less common is “ragged left” justification, wherein the rightmost character is all or most lines is aligned with the assigned right margin.

Other visual characteristics, such as line length, sentence spacing, paragraph spacing, etc. operate in generally the same manner as the foregoing visual characteristics.

Referring now to FIGS. 2-4, exemplary enhanced texts which may be created by the invention after it receives the text of FIG. 1 are depicted. FIG. 2 illustrates enhanced text created from the received text of FIG. 1 after the visual characteristic of font case is regularly varied between upper and lower case every three alphanumeric characters. Expressed differently, the font case is sequentially varied with a change frequency of three wherein the change unit is one alphanumeric character: after every three change units (alphanumeric characters), the font case is changed from lower case to upper case (or vice versa). If the change unit was instead one word, wherein a word is defined as one set of alphanumeric characters bounded by non-alphanumeric characters, a change frequency of three would result in font case being changed after every three words. Similarly, if a change unit was one sentence, with a sentence being defined as a set of alphanumeric or other characters bounded by punctuation characters such as periods, question marks, or exclamation points, a change frequency of three would result in font case being varied every three sentences.

FIG. 3 illustrates a different enhanced text which may be created from the received text of FIG. 1 after the visual characteristic of font size is regularly (sequentially) varied between 12-point, 14-point, and 10-point type (in that order), with a change frequency of two and the change unit set to one word (i.e., one set of bounded alphanumeric characters). Thus, the font size varies in the foregoing order every two words. Additionally, the visual characteristic of font type is randomly varied between the Arial, Times, and Courier fonts with a change frequency of four and the change unit set to one alphanumeric character. Thus, the font type changes every four alphanumeric characters.

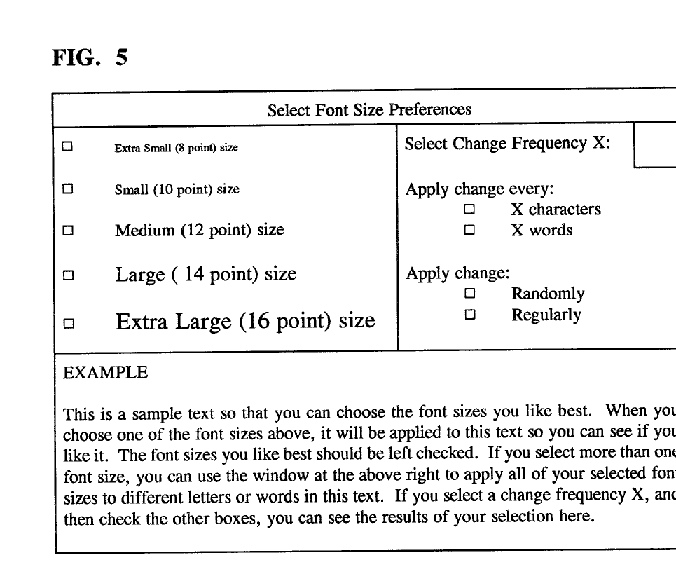

Finally, FIG. 4 illustrates an exemplary enhanced text created from the received text of FIG. 1 after the visual characteristic of font size is randomly varied between 10-point, 12-point, and 14-point type with a change frequency of four and the change unit set to one word, so that the font size changes every four words. Additionally, the visual characteristic of word spacing is regularly (sequentially) varied between 1, 2, and 3 spaces every with a change frequency of three and the change unit set to one word, so that the spacing changes after every three words. Further, the visual characteristic of line spacing is randomly varied between 1, 1.25, 1.5, and 2 spaces with a change frequency of two and the change unit set to one line, resulting in a change of line spacing every two lines of text.

It should be understood that the foregoing examples represent only a small sample of the various types of enhanced text that can be produced from the input text of FIG. 1, and that many other enhanced texts may be created depending on the choice of visual characteristic, change frequency, change unit, and type of change (regular/sequential or random). It is believed that by varying the visual characteristics of the input text in this manner so that the resulting enhanced text has greater variety in its appearance, those who have reading disorders may achieve higher reading speed and comprehension than they would using “ordinary” text. The variety in the enhanced text provides greater stimulation to the visual processing centers of the right hemisphere of the brain, which then complements the analytical and cognitive processing occurring in the written language centers of the left hemisphere of the brain. Thus, the enhanced text allows reading to become more of a “whole brain” process, rather than one which is primarily devoted to left-brain processing.

The invention may be implemented in different forms, with software or firmware form being particularly preferred. Coding may occur in virtually any common software language, including the “macro” programming languages of many common word processing programs so that the invention may be directly implemented on a word processor.

It should be understood that different forms of random and regular variation of visual characteristics may occur. By “regular variation”, this term is intended to mean that the selected visual characteristic in question is sequentially varied among its chosen alternatives (for example, among 12-point, 14-point, and 10-point type in FIG. 3) at a predetermined change frequency of every X change units (wherein the change unit is an alphanumeric character, word, sentence, line, paragraph, or other measure of text). This change frequency X may be selected by the user; randomly selected by the invention; or could be incremented, decremented, or randomly varied after one or more change units so that the change frequency is not constant throughout the text. By “random variation”, this term is intended to mean that the selected visual characteristic in question may be varied randomly at some change frequency X (for example, among Arial, Times, and Courier fonts in FIG. 3). Again, the change frequency X may either be selected by the user, or could instead be randomly selected, or could be incremented, decremented, or randomly varied after one or more change units.

Some of the visual characteristics cannot be applied to all text characters at all units of change; for example, if the selected change unit is one character (alphanumeric or nonalphanumeric), and the selected change frequency designates that a change in font case should occur on a nonalphanumeric character, the change naturally cannot occur because non-alphabetic characters do not have font case values. As another example, the visual characteristic of word spacing cannot occur within a word, and specifying a change unit of one character for word spacing will sometimes seek to achieve this result. If the selected change unit and change frequency designates a change in visual characteristic at some portion of text at which the visual characteristic is inapplicable, the invention can process such an instruction by ignoring the designated change in visual characteristic; skipping to the nearest portion of text to which the change can be applied; or taking similar measures.

The invention's ability to recognize change units within the text (i.e., to distinguish alphanumeric characters, words, sentences, etc.) can be done in a variety of ways when the invention is implemented by computer. One simple method is to determine the ASCII value of each character within the text, and determine whether the value rests between 48 and 57 (corresponding to the numbers 0-9), 65-90 (corresponding to uppercase A-Z), 97-122 (corresponding to lower case a-z), or in other ranges (in which case the character is a punctuation or control character). Thus, alphanumeric or other characters can be recognized by their ASCII values; words may be recognized by identifying strings of alphanumeric characters bounded by nonalphanumeric characters; sentences may be recognized by identifying strings of characters bounded by common sentence closure characters (periods, question marks, exclamation marks, and so on); and paragraphs can be recognized by identifying strings of characters bounded by control characters such as “hard returns”. By identifying characters, words, sentences, etc., the invention may effectively pursue the input text and apply the specified changes at the locations specified to or by the invention.

Similarly, variations in visual characteristics may be effected by changing the ASCII values of appropriate characters—for instance, changing the ASCII value of a character with value 97 (lower case “a”) to 65 will change the lower case “a” to upper case “A”. In like manner, insertion of the ASCII values of certain characters or character strings, particularly control characters, can effect a change in the text's visual characteristics at the point of insertion. As an example, the insertion of the ASCII values for a control character and the letter I (often designated cntrl-I) will in many common word processors cause the text to change to the italic font style at the point in the text where the values are inserted. This is merely one method of changing visual characteristics, and others are possible depending on the programming environment in which the input text is received and enhanced.

In the form of the invention which is most preferred by the inventor, the user of the invention is presented with a survey whereby the user is allowed to select from among the various visual characteristics that he wants varied within the input text to be received by the invention. The user may then choose one or more available alternatives presented for that visual characteristic, for example, from among various font size alternatives when the selected visual characteristic is font size. Most preferably, the process of selecting visual characteristics is presented in the form of a survey wherein each of the visual characteristics that can be varied are sequentially presented one at a time, so that at each step of the survey sequence, the user may concentrate on only the particular visual characteristic being presented and may choose from among the alternatives that appear most pleasant to the eye. As an example, with reference to FIG. 5, a portion of a simple exemplary survey for the visual characteristic of font size is presented. The user is presented with a number of font size options, with each font size being both identified and graphically displayed to the user. In FIG. 5, five font size options are presented near the upper left-hand side of the display: X-small (8-point) type, small (10-point) type, medium (12-point) type, large (14-point) type, and X-large (16-point) type. Exemplary text is also displayed to the user at the bottom of the display. Each time one of the font size options is selected by checking its adjacent box, the exemplary text shown at the bottom of the window will be shown in the selected font size so that the user can better determine whether this is a font size which is sufficiently visually appealing, or whether it should be deselected. Near the right-hand side of the window, the user may specify the degree of variation between the selected font sizes by typing a numerical change frequency X into the box near the upper right-hand side of the window, and then selecting the desired change unit (here characters or words). The user may further specify whether the variation should be performed randomly among the selected font sizes or regularly (sequentially) among the selected font sizes. If multiple font sizes are selected but no change frequency X is inserted, or if a change frequency of X=zero is inserted, this may be interpreted as meaning that no change should occur among the selected font sizes and font size should remain constant. The invention can then default to the first-selected font size, or could instead randomly default to one of the selected font sizes.

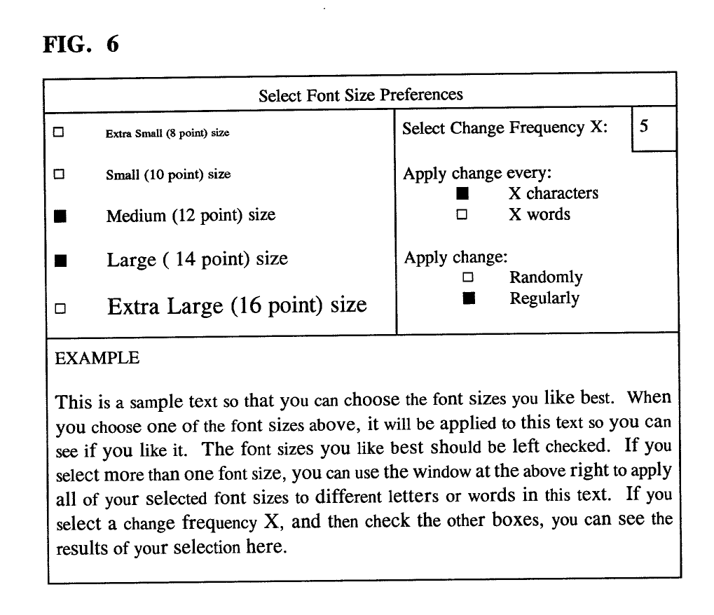

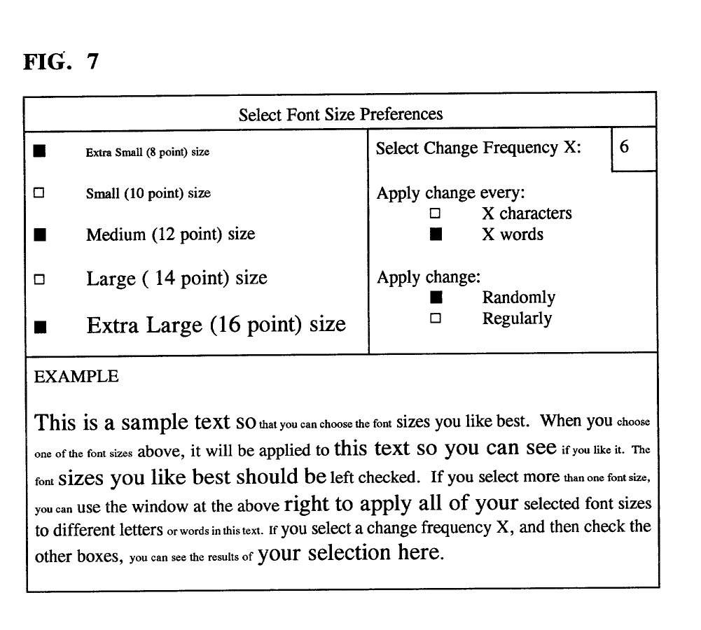

After the change frequency, change unit, and type of change (random or regular) are selected, the resulting variation in the selected font sizes will be illustrated in the exemplary text box below. FIG. 6 illustrates an example wherein the user chooses small, medium, and large font sizes; a change frequency of every five (alphanumeric) characters; and the change being applied on a regular basis. The exemplary text then illustrates a sequential change between small, medium, and large font sizes every five alphanumeric characters. FIG. 7 then illustrates where X-small, medium, and X-large type are chosen; the change frequency is set to every six change units; the selected change units are words; and the changes are applied randomly. Thus, every six words, the font size of the exemplary text changes randomly between X-small, medium, and X-large type.

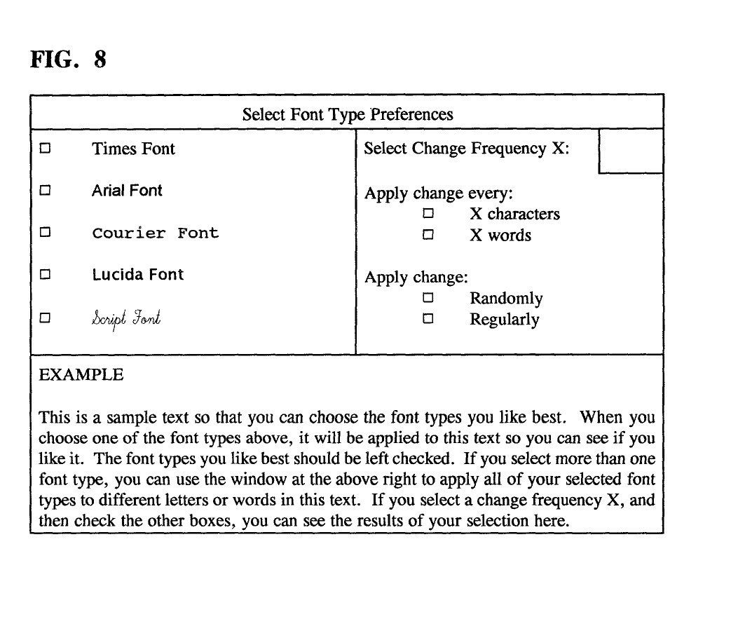

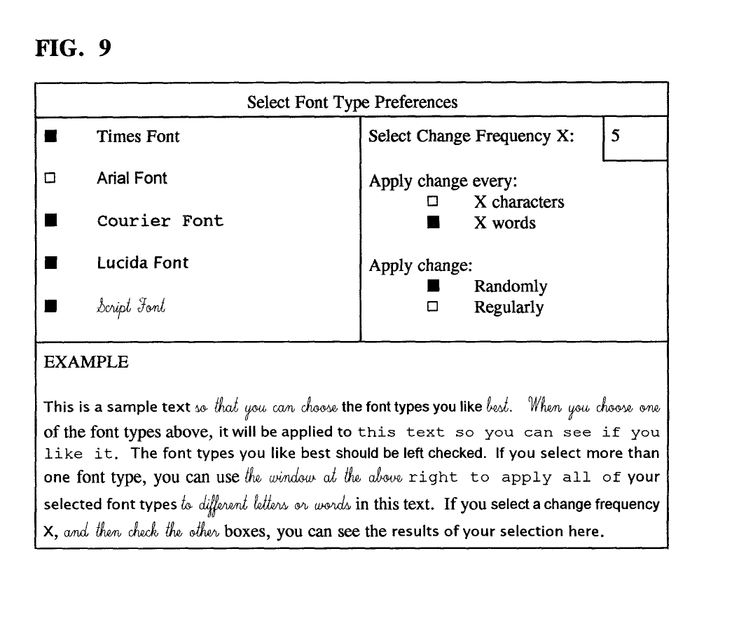

After the user selects his or her font size preferences, these preferences can be stored to a format file and the user may be provided with subsequent survey screens for selecting the user's most preferred options for other visual characteristics, for example, the font types he likes best, the font colors he likes best, the word spacing he likes best, etc. To illustrate, FIG. 8 illustrates an exemplary survey screen for the visual characteristic of font type, and FIG. 9 illustrates the survey screen after the user specifies random variation between Times, Courier, Lucida, and Script every six words.

After the user completes the survey, the user's file will have the user's preferences for all of the presented visual characteristics stored. When the file is then applied to an input text received by the invention, the selected visual characteristics will be simultaneously applied to the input text to generate enhanced text. The same format file may be applied to a number of different input files. If the user wishes, he may go back and modify his preferences for the visual characteristics at any time.

A number of modifications may be made to the foregoing survey scheme, with examples now being presented. First, rather than merely selecting preferred alternatives for each visual characteristic, the user may select alternatives in ranked order; for example, in FIG. 7, the user might select medium size as a first preference, X-large as a second preference, and X-small as a third preference. These rankings may then be used in different ways. As an example, when accessing later survey screens, all text within those survey screens might then be displayed in the user's previously selected top-ranked visual characteristic option. Thus, if the user chose medium font size as the most preferred font size in FIG. 7, when accessing the subsequent font type screen of FIGS. 8 and 9, all text on the font type screen would be displayed in the selected medium font size. As a result, the user's most preferred selections for visual characteristic alternatives will be successively applied to each subsequent survey screen so that the user may see the cumulative effect of his first choices.

Second, the rankings for the visual characteristic preferences might additionally or alternatively used to weight the user's chosen change frequencies—for example, the selected change frequency could be slightly modified to display the user's most preferred visual characteristic alternatives with greater frequency, and lower-ranked visual characteristic alternatives with lesser frequency—or the rankings might be used to automatically generate change frequencies without requiring the user to specify them.

It is understood that the various preferred embodiments are shown and described above to illustrate different possible features of the invention and the varying ways in which these features may be combined. Apart from combining the different features of the above embodiments in varying ways, other modifications are also considered to be within the scope of the invention. Following is an exemplary list of such modifications.

First, it should be understood that the invention may process change frequencies in different ways than those depicted in the foregoing examples. For example, the examples shown in the drawings often processed change frequencies using change units of one alphanumeric character. Change units could instead be set in one absolute character (i.e., in one alphanumeric or nonalphanumeric character), so that a selected change frequency X would result in a change in visual characteristics every X characters, regardless of what those characters might be. Alternatively, change units may encompass selected alphanumeric and/or nonalphanumeric characters and could exclude others. For example, if a change unit was measured in one character (wherein such character is chosen from the set of alphanumeric characters and also the nonalphanumeric characters of commas and periods), a selected change frequency X would change its corresponding visual characteristic only after X characters from within this set were encountered. Similarly, change units of words, sentences, lines, paragraphs, etc. may result in different effects if the definitions of words, sentences, lines, paragraphs etc. are different.

Second, the visual characteristics to be applied to the received text could be selected automatically, as by randomly selecting a subset of visual characteristics from a set of predetermined visual characteristics. For example, from among the predetermined set of font case, font type, font size, font color, word spacing, and line spacing, the invention might randomly choose the subset of font type, font size and word spacing, and might also randomly choose from among the various alternatives available for each chosen visual characteristic (e.g., different font types may be randomly chosen where the visual characteristic of font type is chosen). Alternatively, predefined subsets of visual characteristics may be provided, and the invention could choose from among these subsets and apply the chosen subset. For example, subset 1 might consist of font case, font type, and font size; subset 2 might consist of font type, font size, and font color; subset 3 might consist of font size, font color, and word spacing; and so on. The invention might then randomly choose one of these subsets to be applied to the received text, as well as the various alternatives available for each visual characteristic.

Third, the variation between the various chosen alternatives for each visual characteristic may occur in different ways than those described previously. For example, the user may simply be presented with a set of predetermined visual characteristics, and may manually select from this set one or more visual characteristics that the user wishes to vary, and may also select from among the preferred alternatives for the selected visual characteristics (e.g., the user may select preferred font types where the visual characteristic of font type is in issue). The selected alternatives for the visual characteristics may then be applied to the input text at a randomly selected change frequency without the user's need to specify change units or a change frequency.

Fourth, the visual characteristics survey may be periodically presented to the same user at different times, with the visual preferences being provided for selection in a different orders. For example, when the user first utilizes the invention, the user might first be provided with the option to choose the preferred font type(s); then the preferred font case(s); and then the preferred font size(s); and so on. When the user then uses the invention at a different time, the survey might be presented again and might first ask the user to select the preferred line spacing(s); then the preferred font type(s); then the preferred font case(s); and so on. By varying the order of the visual characteristics when the user selects his preferences, the invention can at least partially account for earlier selections potentially biasing later selections. If a different order of presentation results in the user selecting different preferences, different enhanced text format files can be generated for the same user, and the user may later choose from among them and decide which one(s) he likes best for application to received input texts.

Fifth, if desired, the invention can “optimize” the reader's reading environment by determining over time those subsets of visual characteristics to which the reader has greatest response, and storing these subsets for preferred use. For example, the reader's response to a displayed enhanced text may be determined—as by measuring one or more of reading speed, comprehension, and/or degree of interest—and this response can be compared with the same reader's response to other enhanced texts produced by random selection of visual characteristics. The invention then only need save the most effective enhanced text formats, i.e., those N subsets of visual characteristics which result in greatest reader response (where N is some integer number). The invention may then randomly apply these N subsets to later input texts received by the invention, and may also occasionally introduce new subsets of randomly generated visual characteristics. The reader's response to the new subsets can then be compared to that of the previously-stored N subsets. If any of the new subsets generate greater reader response than any subsets within the N stored subsets, the new subset(s) generating such response may replace the subset(s) in the N stored subsets to which they are superior. Thus, the invention will come to store the N subsets of visual characteristics which generate greatest reader response, and the N subsets will occasionally be updated to replace a subset of visual characteristics stored therein with a new subset having greater reader response. The N stored subsets will therefore over time converge to those subsets of visual characteristics which are “best.”

Finally, the invention can implement even more dynamic visual characteristics if the enhanced text is displayed on media such as a monitor or electronic display. As examples, the invention could incorporate any of the features of periodically or randomly changing visual characteristics within the text; moving/animated text; or changing backgrounds whereupon the text is displayed. However, given the state of the art at the time this document is prepared, such developments cannot be implemented on the printed page, which is the preferred medium for displaying the enhanced text; electronic monitors and displays, even when provided on laptop and palmtop computing devices, are not ideally portable and inexpensive. Paper does not suffer from these disadvantages, and additionally use of printed enhanced text may help those with reading disorders to overcome any fear of the printed page. It is expected that as further developments occur in the field of portable flat-panel electronic displays and “electronic paper”, these dynamic features might be more feasible and usefully implemented.

The invention is not intended to be limited to the preferred embodiments described above, but rather is intended to be limited only by the claims set out below. Thus, the invention encompasses all alternate embodiments that fall literally or equivalently within the scope of these claims. It is understood that in the claims, means plus function clauses are intended to encompass the structures described above as performing their recited function, and also both structural equivalents and equivalent structures. As an example, though a nail and a screw may not be structural equivalents insofar as a nail employs a cylindrical surface to secure parts together whereas a screw employs a helical surface, in the context of fastening parts, a nail and a screw are equivalent structures.

What is claimed is:

1. A method of enhancing text for human readers comprising:
a. receiving text, the text including words arranged in a predetermined order, wherein each word includes one or more characters;
b. creating enhanced text by automatically assigning to the received text at least one of the following visual characteristics:
(1) a font case;
(2) a font size;
(3) a font type;
(4) a font color;
wherein
(a) the assigned visual characteristics are varied N times within the enhanced text, N being an integer greater than 1;
(b) such variation is not present in the received text; and
(c) the enhanced text contains the words of the received text in the predetermined order in which it was received;
c. visually displaying the enhanced text.

2. The method of claim 1 further comprising the step of manually selecting the visual characteristics prior to the creation of the enhanced text.

3. The method of claim 2 wherein the selected visual characteristics are stored for later assignment to different received texts.

4. The method of claim 1 further comprising the step of manually selecting a change frequency X (X being an integer number), whereby the selected change frequency results in variation of at least one of the assigned visual characteristics:
a. every X characters, or
b. every X words, thereby resulting in the variation of the assigned visual characteristics N times within the enhanced text.

5. The method of claim 1 further comprising the step of automatically and randomly varying at least one of the assigned visual characteristics when assigning the visual characteristics to the received text.

6. The method of claim 1 wherein N is greater than 10.

7. The method of claim 1 wherein word spacing is also a visual characteristic which may be automatically assigned to the received text.

8. The method of claim 1 wherein the enhanced text is visually displayed in more than one line of text, and wherein line spacing is also a visual characteristic which may be automatically assigned to the received text.

9. A method of enhancing text for human readers comprising:
a. receiving text including multiple lines of words, each word being formed of one or more characters;
b. automatically assigning to the received text at least one of the following visual characteristics:
(1) a font case;
(2) a font size;
(3) a font type;
(4) a font color;
(5) a word spacing; or
(6) a line spacing, and
c. visually displaying the received text in multiple lines with the assigned visual characteristics,
wherein:
(a) at least one of the assigned visual characteristics is varied at least once per line, and
(b) such variation is not present in the received text.

10. The method of claim 9 wherein if any of the visual characteristics of font size, font type, font color, and word spacing are assigned, said assigned visual characteristics are varied at least twice per line.

11. The method of claim 9 further comprising the step of manually selecting the visual characteristics to be automatically assigned to the received text.

12. The method of claim 11 further comprising the step of storing the selected visual characteristics for later assignment to different received texts.

13. The method of claim 9 further comprising the step of manually selecting a change frequency X prior to the assignment of at least one of the visual characteristics to the received text, whereby the selected change frequency results in variation of at least one of the assigned visual characteristics in one of:
a. every X characters,
b. every X words, or
c. every X lines.

14. The method of claim 9 wherein the assignment of at least one of the visual characteristics to the received text occurs randomly.

15. Software for enhancing text for human readers wherein the software, upon receiving text including words arranged in a predetermined order, wherein each word includes one or more characters, performs the following steps:
a. automatically assigning to the received text at least one of the following visual characteristics:
(1) a font case;
(2) a font size;
(3) a font type;
(4) a font color;
wherein the assigned visual characteristics are varied at least twice within the text, such variation not being present in the received text;
b. visually displaying the received text in the predetermined order with the assigned visual characteristics applied.

16. The software of claim 15 wherein the assigned visual characteristics are selected by a user prior to automatic assignment to the received text.

17. The software of claim 15 wherein the step of obtaining a user-selected change frequency X is performed prior to automatically assigning visual characteristics to the received text, and wherein the selected change frequency X results in the variation of at least one of the assigned visual characteristics:
a. every X characters, or
b. every X words.

18. The software of claim 15 wherein the change frequency is stored for later application to different received texts.

19. The software of claim 15 wherein the assigned visual characteristics are varied at least every two words.

20. The software of claim 15 wherein the assigned visual characteristics are varied at least once per word.
